(19) United States
(12) Patent Application Publication
(10) Pub. No.: US 2007/0038727 A1
(43) Pub. Date: Feb. 15, 2007

(54) ELECTRONIC MENU AND CONCIERGE SYSTEM

(75) Inventors: James W. Bailey, Atlanta, GA (US); Mark Alan Snyder, Atlanta, GA (US); Al Reingold, Roswell, GA (US)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(73) Assignee: SIX CONTINENTS HOTELS, INC., Atlanta, GA (US)

(21) Appl. No.: 11/460,939

(22) Filed: Jul. 28, 2006

Related U.S. Application Data
(60) Provisional application No. 60/704,251, filed on Aug. 1, 2005.

(51) Int. Cl. G06F 15/16

(52) U.S. Cl. 709/219

(57) ABSTRACT

An electronic menu and concierge system (100) for the travel and hospitality industry. The electronic menu and concierge system (100) is a centralized, Internet-hosted service that is accessible by hotel guests and visitors. The system may provide hotel information, such as hotel events (162), directions (248), and local attractions (166). Food and/or beverages services (270) and merchandise may also be ordered through the system (100).

### REFERENCE TO RELATED APPLICATION

This application claims priority to U.S. provisional patent application Ser. No. 60/704,251, filed Aug. 1, 2005, and incorporated herein by reference.

### TECHNICAL FIELD OF THE INVENTION

The present invention is directed to computer systems, and more specifically to the use of a computer system in the hospitality and travel industry.

### BACKGROUND OF THE INVENTION

In the hospitality and travel industry, such as hotel services, guests are often provided enhanced services and amenities to make travel more comfortable, and help integrate a guest's accommodations or other travel services with his or her trip. As an example, a hotel may provide food services, such as via a restaurant or room service, information about local attractions and events, directions to and information about tourist attractions and local restaurants, or other information that may be of use to a guest.

At present, information is provided by a hotel to a guest in a number of different ways. As an example, brochures may be available at a reception desk. A paper guest services directory may be provided in the guest's room. A guest may consult with a concierge for many local events or activities. A dedicated hotel services channel may be provided on the guest's television set, and may describe some services available locally or through the hotel. Other information may be posted on bulletin boards within the lobby of the hotel, or at an entrance to a conference center for the hotel.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, an electronic menu and concierge system for the hospitality and travel industry is provided. As a nonlimiting example, the electronic menu and concierge system may be utilized with a hotel or hotels in a hotel chain or a conglomerate of chains of hotels, although the system may be used in other travel service areas such as airlines, bus transport, conference centers, cruise ships, and other hospitality and travel services.

In accordance with an embodiment, the electronic menu and concierge system is a centralized, Internet-hosted service that is accessible by hotel guests and visitors. Hotels participating in the service are part of a centralized web hosted system that provides information to users via the user's individual computers or computing devices. As an example, an authorized user may access the system via a laptop computer or other computing device through a wired or wireless Internet Access network provided by the hotel. Alternatively, a user may access the web service through a computer device, such as a PC or a kiosk, provided by the hotel, which may be located, for example, in a lobby or a business center for the hotel. In addition, in accordance with an embodiment, authorized users may access a portion of the system while not on the premises of the hotel, for example via a website through the Internet or when traveling to or from the hotel on a shuttle bus.

The system may provide a number of different features. As an example, hotel information may be provided, such as directions from and to the hotel, history of the hotel or hotel chain, or hotel events, such as conference events. Other features, such as games, may be provided for the entertainment of the guest. The directions may incorporate some logic, including most recently requested directions, most frequently requested directions, and so forth. In addition, logic may be used for each hotel for providing a standard set of directions (e.g., closest airport, closest rental car agency, closest shopping, etc.).

In accordance with an embodiment, food and/or beverages and related services may also be ordered through the system. In accordance with an embodiment, additional food and/or beverage information may be provided, such as, by way of nonlimiting example, caloric content, nutritional information, ingredients, and recipes. The food or beverages may be ordered as part of room service, or as part of a restaurant service. In accordance with an embodiment, if a particular menu item is no longer available (for example, if supplies have been exhausted) then the item may be removed from the menu display entirely so as to present only currently available items to the guest. Additionally, by way of nonlimiting example, this functionality can also be utilized to present “daily specials” in a more streamlined and efficient manner than with paper menus. The restaurant services may be ordered, for example, while a guest is seated at a table in a restaurant for the hotel. Alternatively, a guest may order the restaurant services from another position within the hotel for later dining, delivery, or for pick up.

In addition, a function may be provided for ordering room service. If room service is provided, the room service may be utilized by a guest to have food ordered to a room, or to another location in the hotel, such as in the lobby or by a pool. To prevent prank orders, an authorization or exchange method may be utilized whereby the user ordering room service is confirmed. As one example, an Internet Protocol (IP) address may be associated with a particular room to confirm that an order is generated from the room. As another example, a user may leave a telephone number with the order, and a call may be placed before the order is entered into a point of sale system of the hotel kitchen.

Similarly, a storefront may be provided through the system, wherein a user may order goods, including, but not limited to, souvenirs, clothes, sunscreen, or toiletries. Other goods may be sold, and the transactions may be handled much like the room service transactions, including verification. Alerts, such as wake-up calls for hotel guests, may be handled in the same manner.

In accordance with another embodiment, localized information may be provided via the system. Examples include, but are not limited to, information about shopping venues, weather, local events, taxis and other ground transportation services, and local telephone numbers. If food services are provided through the system, local menu variances, such as different prices, specials, or menu items may be provided.

The system may also provide information about how to make new, or change existing, hotel reservations, or to check on the status of airline flights and related information, such as arrival and departure times. In accordance with an embodiment, a printer may be connected to the system which permits an authorized user to print a document, such as an airline ticket. This feature may require a print request from a specific terminal, such as a lobby computer or a computer in a business center. Alternatively, printer access may be available from any authorized computer connected to the system. If so, a user may then have that document delivered to the user's room, or may go retrieve the document.

In accordance with another embodiment, a postcard subsystem is provided within the electronic menu and concierge system that permits a user to send a personalized postcard-shaped electronic message to an Internet user. The postcard may be, for example, personalized to the hotel or the location of the hotel, or may be generic in design. In accordance with an embodiment, the postcard subsystem may provide advertising opportunities, dynamic graphics (such as, by way of nonlimiting example, Macromedia Flash programs) and the ability to send postcards to multiple recipients.

In accordance with an embodiment, the system may be deployed such that, upon exiting the system and browsing the Internet, a limited system toolbar (such as, by way of nonlimiting example, a top or bottom border of the Internet browser) may still be present to allow the user easy access to return to the system. In accordance with an embodiment, such a toolbar may also provide global functionality, such as hyperlinks to the hotel's reservations website or other system-defined websites.

The electronic menu and concierge system may include many other features, such as surveys and help areas. Customer data may be maintained to provide more personalized service. This customer information may include preferences of a customer, so that when a customer returns to a hotel in the hotel chain, the customer may be provided individualized service based upon prior requests by the customer.

Thus, the electronic menu and concierge system may be utilized to provide much of the information previously provided by a paper guest service directory and through a concierge service. In addition, because the system can be accessed remotely, other features may be provided, such as advance check-in or remote access to view hotel events.

Other features of the invention will become apparent from the following detailed description when taken in conjunction with the drawings, in which:

### BRIEF DESCRIPTION OF THE DRAWINGS

FIG. 1 is a block diagram representing a computer network into which the present invention may be incorporated;

FIG. 2 is a block diagram of an architecture of a computer through which the present invention may be implemented;

FIG. 3 is a block diagram representing a centralized electronic menu and concierge system in accordance with an embodiment of the invention;

FIG. 4 is a block diagram representing components of one of the hotels shown in FIG. 3 in accordance with an embodiment;

FIG. 5 shows a block diagram generally representing components of a data center of FIG. 3 in accordance with an embodiment of the invention;

FIG. 6 is a block representation of an XML file for storing localized information for a hotel in accordance with an embodiment of the present invention;

FIG. 7 shows a graphical user interface that may be utilized with a system in accordance with an embodiment of the invention;

FIG. 8 illustrates a menu system revealing nested menu options for the graphical user interface of FIG. 7;

FIG. 9 shows a representation of nested menu options for hotel events in accordance with an embodiment of the invention;

FIG. 10 is a representation of an example of a user interface showing a message board in accordance with an embodiment of the invention;

FIG. 11 is a representation of an example of a user interface showing directions in accordance with an embodiment of the invention;

FIG. 12 shows a room service user interface in accordance with an embodiment of the invention;

FIG. 13 shows a flow chart with steps for processing a room service order in accordance with an embodiment of the invention;

FIG. 14 shows menu items that may be available at an “Airlines” page in accordance with an embodiment of the invention;

FIG. 15 shows menu items under a “Shopping” link in accordance with an embodiment of the invention;

FIGS. 16-18 show graphical user interfaces for sending and receiving an electronic postcard in accordance with an embodiment of the invention;

FIG. 19 shows a check-in page in accordance with an embodiment of the invention; and

FIG. 20 shows a reservations page that may be presented to a user in accordance with an embodiment.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention.

Briefly described, the present invention provides an electronic menu and concierge system for the hospitality and travel industry. Although the described system includes both concierge and menu components, embodiments of the invention may include one or both of these, or components of one or both of these.

In the described embodiments, the electronic menu and concierge service is utilized with hotels of a hotel chain or hotels in a conglomerate of hotel chains, but the system may alternatively be utilized with a loose association of hotels, or may be used in other travel and hospitality industries, including, but not limited to, airlines, bus transport, conference centers, cruise ships, and other hospitality and travel services, or any combination of these service industries.

Prior to proceeding with a description of the various embodiments of the invention, a description of an example computer and an example networking environment in which the various embodiments of the invention may be practiced will now be provided. Although it is not required, the present invention may be implemented by programs that are executed by a computer. Generally, such programs include routines, objects, components, data structures and the like that perform particular tasks or implement particular abstract data types. The term “program” as used herein may connote a single program module or multiple program modules acting in concert. The term “computer” as used herein includes any device that electronically executes one or more programs, such as personal computers (PCs), hand-held devices, tablet PCs, multi-processor systems, microprocessor-based programmable consumer electronics, network PCs, minicomputers, mainframe computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

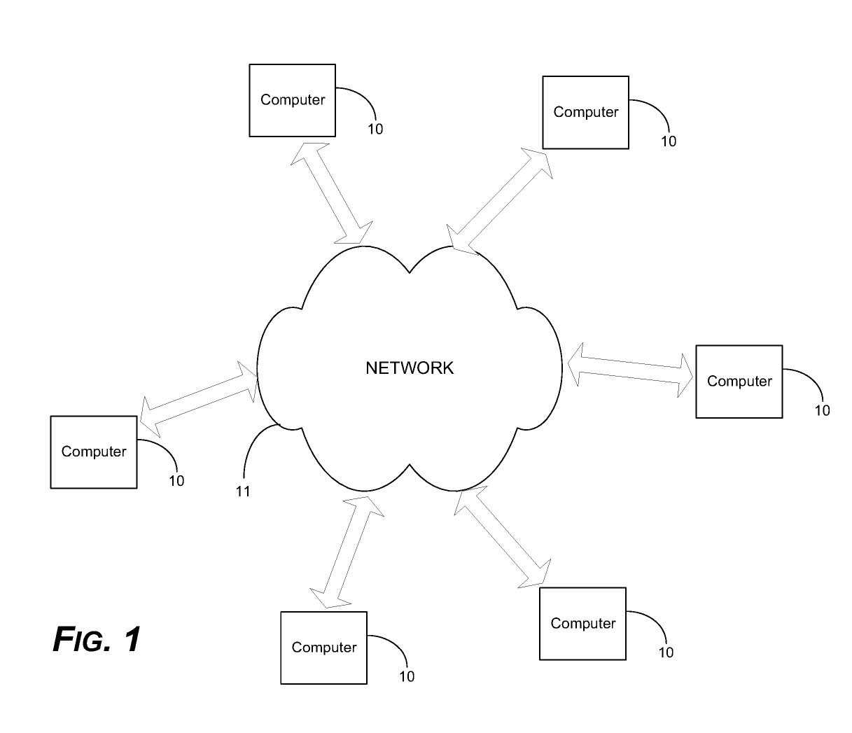

An example of a networked environment in which the invention may be used will now be described with reference to FIG. 1. The example network includes several computers 10 communicating with one another over a network 11, represented by a cloud. The network 11 may include many well-known components, such as routers, gateways, hubs, etc. and allows the computers 10 to communicate via wired and/or wireless methodologies. When interacting with one another over the network 11, one or more of the computers 10 may act as clients, servers or peers with respect to other computers 10. Accordingly, the various embodiments of the invention may be practiced on clients, servers, peers or combinations thereof, even though specific examples contained herein do not refer to all of these types of computers.

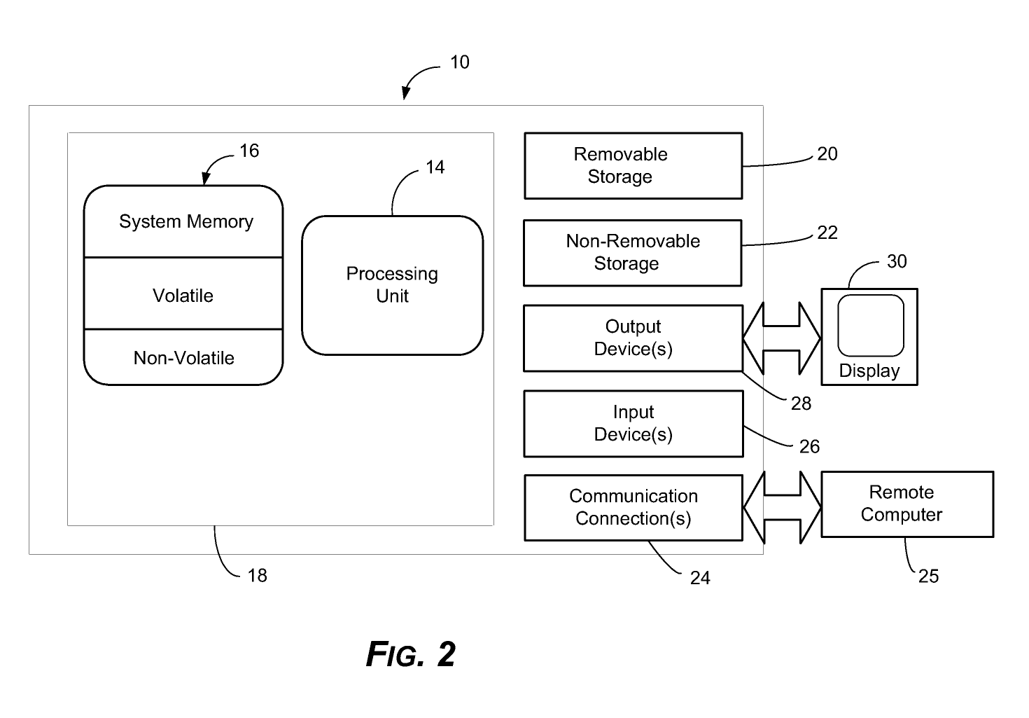

Referring to FIG. 2, an example of a basic configuration for a computer 10 on which all or parts of the invention described herein may be implemented is shown. In its most basic configuration, the computer 10 typically includes at least one processing unit 14 and memory 16. The processing unit 14 executes instructions to carry out tasks in accordance with various embodiments of the invention. In carrying out such tasks, the processing unit 14 may transmit electronic signals to other parts of the computer 10 and to devices outside of the computer 10 to cause some result. Depending on the exact configuration and type of the computer 10, the memory 16 may be volatile (such as RAM), non-volatile (such as ROM or flash memory) or some combination of the two. This most basic configuration is illustrated in FIG. 2 by dashed line 18.

The computer 10 may have additional features and/or functionality. For example, the computer 10 may also include additional storage (removable storage 20 and/or non-removable storage 22) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 10. Any such computer storage media may be part of computer 10.

The computer 10 preferably also contains communications connections 24 that allow the computer 10 to communicate with other devices, such as other computers on the network 11, or a remote computer 25. The remote computer 25 may be configured similar to the computer 10, or differently. A communication connection (e.g., one of the communication connections 24) is an example of a communication medium. Communication media typically embody computer readable instructions, data structures, program modules or other data in a modulated data signal such as a carrier wave or other transport mechanism and include any information delivery media. By way of example, and not limitation, the term “communication media” includes wired media such as a wired network or direct-wired connection, and wireless media such as acoustic, RF, infrared, and other wireless media. The term “computer-readable medium” as used herein includes both computer storage media and communication media.

The computer 10 may also have input devices 26 such as a keyboard, mouse, pen, voice input device, data disc drives, touch input device, etc. Output devices 28 such as a display 30, speakers, a printer, etc. may also be included. All these devices are well known in the art and need not be discussed at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer 10 of electrical signals representing data in a structured form. This manipulation transforms the data or maintains it at locations in the memory system of the computer 10, which reconfigures or otherwise alters the operation of the computer 10 in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

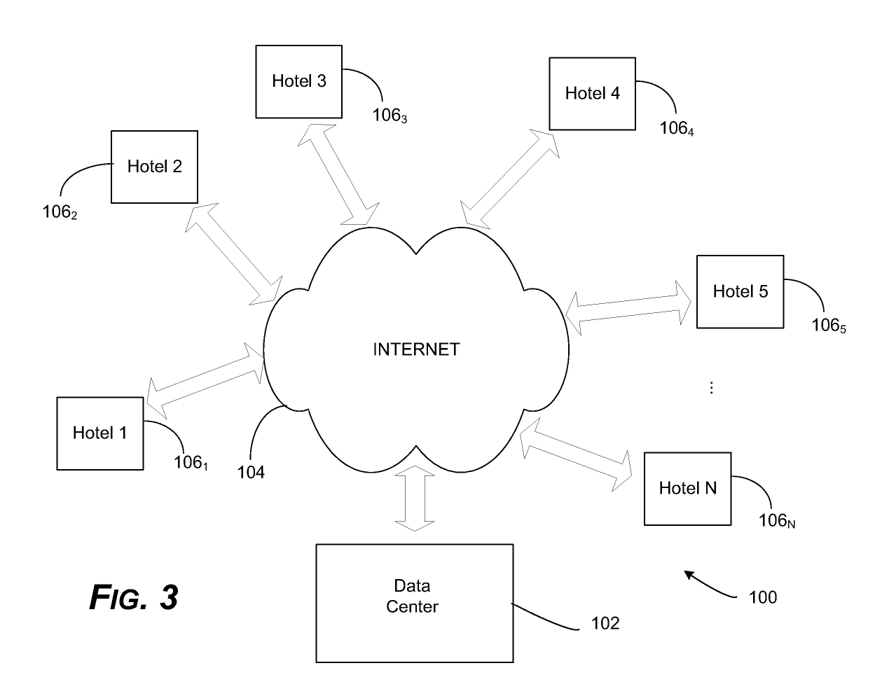

FIG. 3 is a block diagram representing a centralized electronic menu and concierge system 100 in accordance with an embodiment of the invention. The centralized electronic menu and concierge system 100 includes a centralized data system 102 that is accessible via a network, such as the network 11 of FIG. 1. In an embodiment of the invention, the network is the Internet 104, although other networks may be used. The Internet 104, however, is particularly useful in that it permits the system to be easily scalable with an increase in bandwidth connection to the Internet, and in that the Internet is readily available throughout the world.

A number of hotels 106₁, 106₂, 106₃ . . . 106_{N} access the data system 102. The hotels 106 may be associated, for example, by being a part of a chain of hotels, although another affiliation between the hotels may exist (with appropriate network permissions for access).

In an embodiment, each of the hotels 106 deploys the electronic menu and concierge system 100 as a discrete iteration across the network 11. For example, each hotel 106 may have a separate uniform resource locator (URL), allowing specific content to be applied to each hotel 106.

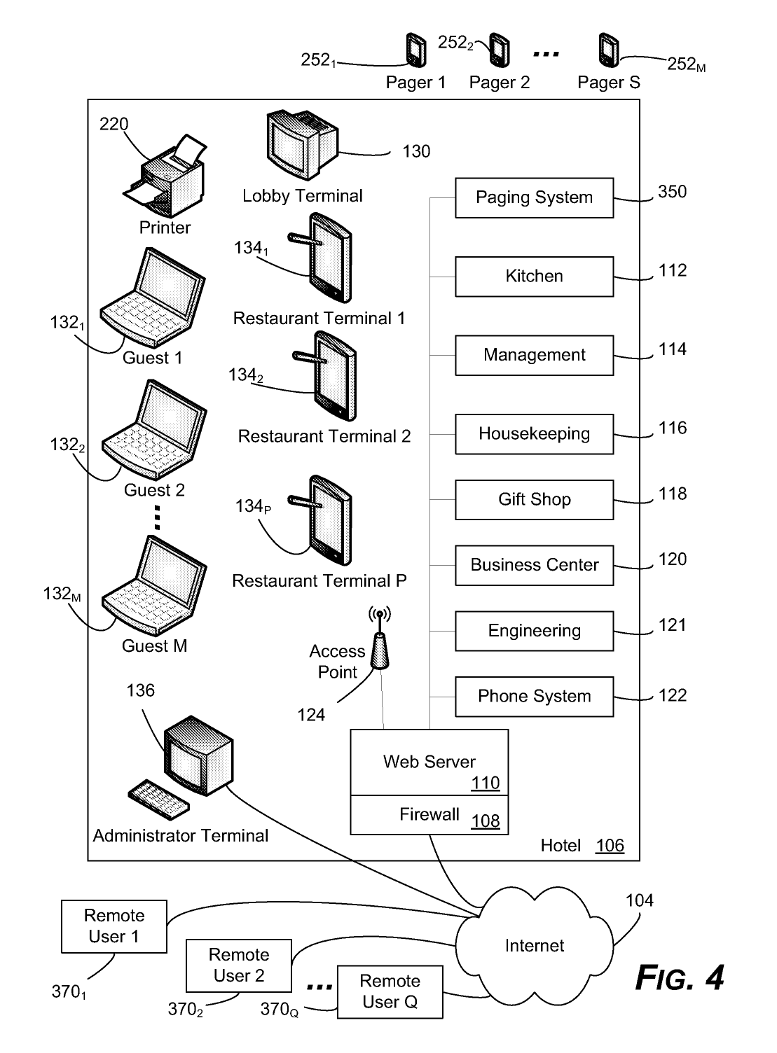

FIG. 4 is a block diagram representing one of the hotels 106 shown in FIG. 3. The hotel 106 is shown in FIG. 4 as having a large number of components. However, it is to be understood that not all components necessarily are utilized for each embodiment of the invention. Moreover, more components may be provided than shown.

In the embodiment shown in FIG. 4, the hotel 106 includes a web server 110 protected by a firewall 108 and connected to the Internet 104. The web server 110 may be any suitable web server, such as Microsoft Corporation's Internet Information Server (IIS). In the shown embodiment, the web server 110 is connected to a number of different components within the hotel, including a kitchen terminal 112, a management control terminal 114, a housekeeping terminal or handheld device(s) 116, a gift shop terminal 118, a business center computer 120, an engineering terminal or handheld device(s) 121 and a phone system interface 122. The web server 110 may be connected to these components either through wired media or wireless media. To this end, a network, such as the network 11, is utilized to connect these components to the web server 110.

The web server 110 shown in FIG. 4 is also connected through an access point 124. As is known, typical infrastructure mode wireless networks include one or more access points (APs), such as the access point 124, through which a wireless device may connect to the network. The access point 124 serves as a bridge between wireless and wired networks. A hotel, such as the hotel 106, may include a number of access points, for example one each for each guest room, one in the lobby, and one or more access points in the conference spaces for the hotel 106.

In the embodiment of the hotel 106 shown in the drawing, a computer, such as a lobby terminal 130, is provided in the lobby for access by users. This lobby terminal 130 may be connected wirelessly or via wired media to the web server 110. More terminals may be provided throughout the hotel. Also, in the embodiment shown, a number of guest computers 132₁, 132₂ . . . 132M are shown in the hotel 106. The guest computers 132 may be connected to the web server 110 via either wired or wireless media. The guest computers may be, for example, terminals provided in each guest room by the hotel 106. Alternatively, the guest computers 132 may be laptop or notebook computers that are brought by or that are provided for guests. These guests may be either overnight guests within the hotel 106, or individuals in the hotel for other reasons, such as to attend a conference. In addition, if desired, web connection functionality may be provided via television sets in the guest rooms, and these web-enabled television sets may represent one or more of the guest computers 132.

In the embodiment shown in the drawings, the hotel 106 includes a number of restaurant terminals 134₁, 134₂ . . . 134P. These restaurant terminals 134 may be, for example, tablet PCs that are available at each dining location (e.g. table or booth) in a restaurant at the hotel 106. The restaurant terminals 134 may be connected to the web server 110 via wireless or wired media. Guests or visitors with laptop PC's with Wi-Fi capabilities may connect to the network in these venues.

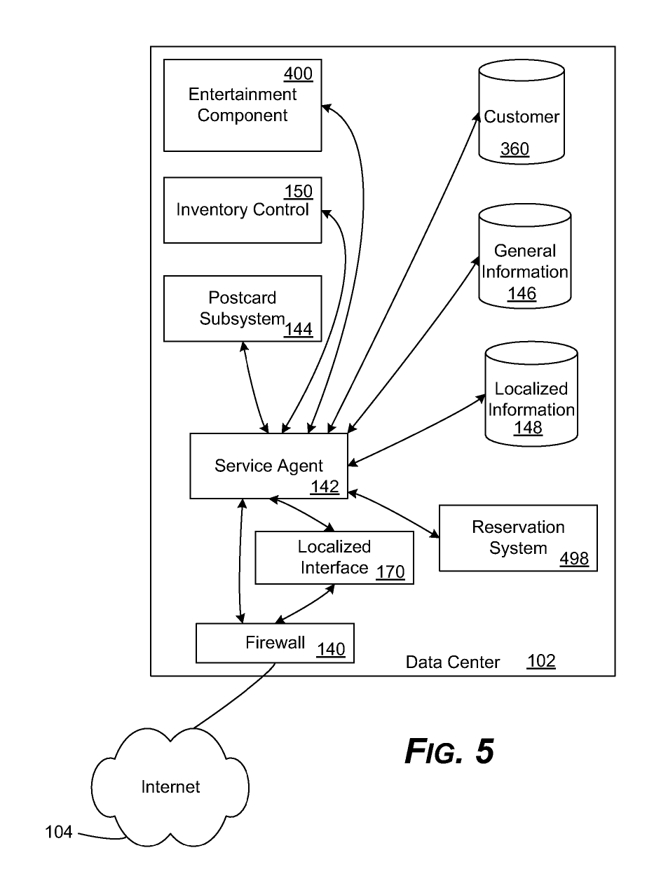

FIG. 5 shows a block diagram generally representing components of the data center 102 in accordance with an embodiment of the invention. In the embodiment shown, a firewall 140 protects a service agent 142 for connection to the Internet 104. The service agent 142 is connected to a postcard subsystem 144, a general information database 146, and a localized file database 148. Although depicted as separate databases, the information stored within the databases 146, 148 may be maintained in a single database, or may be distributed over multiple, local or remote, databases. An inventory control 150 is also included within the data center 102 and is connected to the service agent 142.

Generally described, the centralized electronic menu and concierge system 100 is configured such that a user may access the system, for example via the lobby terminal 130, one of the guest computers 132, or one of the restaurant terminals 134. Information requested from one of these computers or terminals is sent via the web server 110 to the data center 102, where the service agent 142 retrieves appropriate information and provides it back to the requesting computer. Information may be retrieved from the inventory control 150, the databases 146, 148, the postcard subsystem 144, and/or via the Internet (e.g., by the service agent 142 providing a link to an external Internet website). In addition or as an alternative, a request sent to the service agent 142 may result in a message or information being sent to or retrieved from the kitchen computer 112, the management computer 114, the housekeeping computer 116, the gift shop computer 118, the business center computer 120, the phone system 122, or another location within the hotel 106 or located external to the hotel. Specific examples are described below.

The information that may be provided by the centralized electronic menu and concierge system 100 includes information that is usable across many of the hotels 106. Such information may be maintained in the general information database 146. In addition, information that is specific to a single hotel 106, or a subset of the hotels, may be maintained in the localized information database 148.

Each of the hotels 106 provides localized information to the data center 102. In an embodiment, this localized information is stored in the localized information database 148. However, if desired, the localized information may be stored at the particular hotel 106, for example at the web server 110. However, by storing information at the data center 102, management of the information may be maintained at the data center 102, avoiding possible unforeseen failures, reducing the need to switch to remotely stored information.

In an embodiment, the localized information is stored in accordance with a schema that may be accessed and used by the service agent 142. In this description and in the following claims, a “schema” is defined as an expression of a shared vocabulary between a plurality of computer systems that allows the plurality of computer systems to process documents according the expressed shared vocabulary. For example, an eXtensible Markup Language (“XML”) schema can define and describe a class of XML documents using schema constructs of an XML schema language. These schema constructs can be used to constrain and document the meaning, usage, and relationships of data types, elements, and their content, attributes and their values, entities and their contents, and notations, as used in XML documents. Thus, any computer system that can access an XML schema can process XML documents in accordance with the XML schema. Further, any computer system that can access an XML schema can compose or modify XML documents for use by other computer systems that can also access the XML schema.

Schema is defined to include Document Type Definitions (“DTD”), such as, for example, DTD files ending with a “.dtd” extension. Schema is also defined to include World Wide Web Consortium (“W3C”) XML Schemas, such as, for example, XML Schema files ending with an “.xsd” extension. A schema may also be defined to include eXternal Data Representations (“XDR”), which is a standard for machine independent data structures for use in remote procedure call systems. However, the actual file extension or type for a particular schema is not important. A schema can be utilized to define virtually any data type including logical, binary, octal, decimal, hexadecimal, integer, floating-point, character, character string, user-defined data types, and combinations of these data types used to defined data structures. XML elements and attributes can be defined to represent data types that are defined by a schema. In this definition and the following claims, “schema-based” refers to being defined by and/or within a schema.

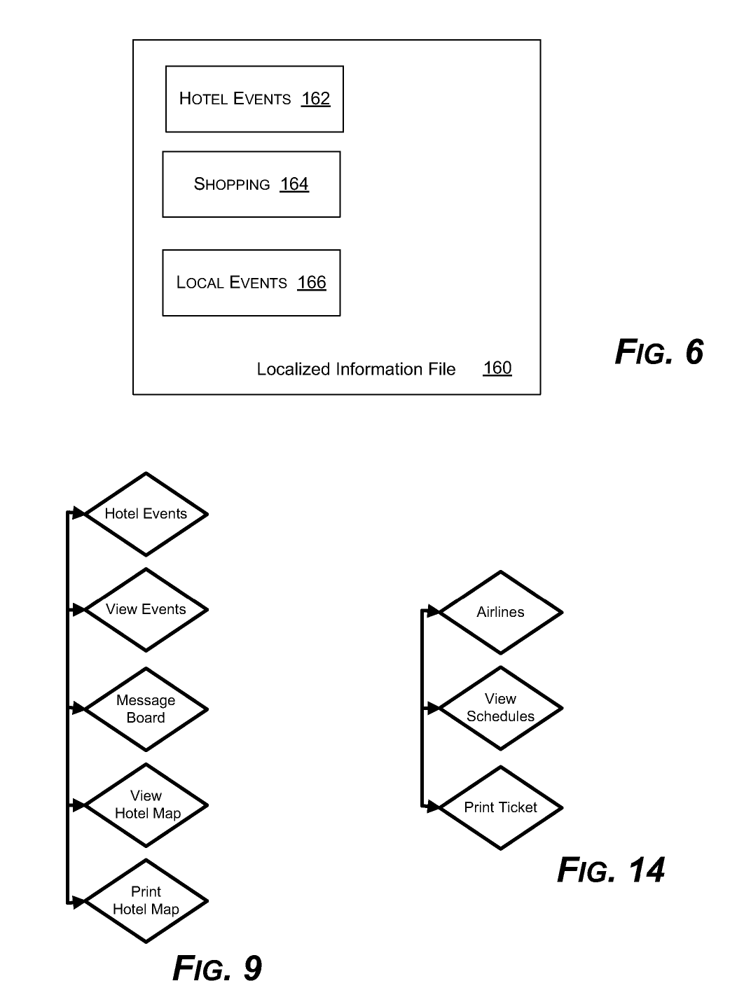

The schema used for storing the localized information may be, for example, an extensible Markup Language (XML) file 160 (FIG. 6). Other schemas may be used, but XML allows designers to create their own customized tags, enabling the definition, transmission, validation, and interpretation of data between applications and between organizations. By utilizing the XML file 160, a number of different computers (e.g., one each for each one of the hotels 106) may easily provide information for the files, and the service agent may easily access and choose to display or otherwise use the information in a file.

The XML file 160 is used as a container for receiving the information from each of the hotels 106. In the embodiment shown in FIG. 6, the XML file 160 includes containers for hotel events 162, local shopping information 164, and local events 166. Additional information may be provided as needed. In addition, although a single XML file 160 is shown, more than one file may be used and, if more than one is used, the files may have different schemas.

The localized information for the file 160 may be forwarded to an administrator of the data center, and populated within the localized information database 148. Alternatively, if desired, a localized management interface 170 (FIG. 5) may be provided for receiving information, such as the files 160, from each of the hotels 106. The interface 170 may also permit editing of existing files 160. To this end, an administrator terminal 136 (FIG. 4) may be provided in each hotel 106 for populating or editing the localized file or otherwise managing data specific to the particular hotel. Access to this administrator terminal 136 may be strictly limited, and access to the file 160 for a particular hotel 106 may require secured authorization. In addition, files or other information sent to the data center 102 may be checked by an administrator of the data center 102 for strict adherence to policy. As an alternative to the administrator terminal, a portal (e.g., via the Internet) may be provided to the system 100 for permitting an authorized user to edit or establish features of the system.

In addition to the information shown within the localized file 160 of FIG. 6, information may be provided to the data center regarding local specials, such as food or pricing specials, specialized menu options, availability of items in a restaurant for the hotel 106 or in the gift shop 118, and/or local phone numbers. Other localized information may be provided. If desired, availability information for menu items or gift shop items may be maintained by the inventory control 150. In addition, in accordance with an embodiment, the inventory control 150 may be used to automatically generate orders for supplies or other inventory, and may be used to generate reports regarding use by a hotel 106 or a plurality of the hotels.

Similar XML or other data schema format files may be maintained by the data center 102 as the general information, for example in the general information database 146. This information may be used by more than one of the hotels 106, thus not requiring multiple hotels to maintain and update duplicative information. A single update to this general information updates data available to each of the hotels 106.

Various embodiments of possible operations performed by the centralized electronic menu and concierge system 100 are now described. The described operations are not meant to be limiting or all-encompassing, but are provided as examples of some features that may be included within the system 100.

Upon starting the system 100, for example at one of the computers 130 or 132, a user is presented with a graphical user interface (GUI) through which a user may send requests to the service agent 142. A user may be required, for example by the web server 110, to provide appropriate credentials (e.g., a user name and password) to access the system 100. A password and user ID may be provided for the user at hotel check in, or a user may have such a password and ID from being a regular visitor of the hotel 106 or the chain of the hotels 106. If the user is using his or her own computer as one of the guest computers 132, then a cookie may be placed on the machine and an IP address may be assigned for the computer in a manner known in the art. As such, particular user patterns or requests may be tracked.

In accordance with an embodiment, a specific IP address is assigned for each room of the hotel 106. In this manner, the system 100 may track the location from which a particular request is sent when the request is sent from a room.

In an embodiment, a disclaimer page and/or rules of engagement will be provided before the user is allowed access to the system 100. After agreeing to terms, an authorized user is provided access to a graphical user interface, such as the graphical user interface 200 shown in FIG. 7. Through the graphical user interface 200, the user may select one of a plurality of menu options, the menu options providing functionality to the features provided by the system 100.

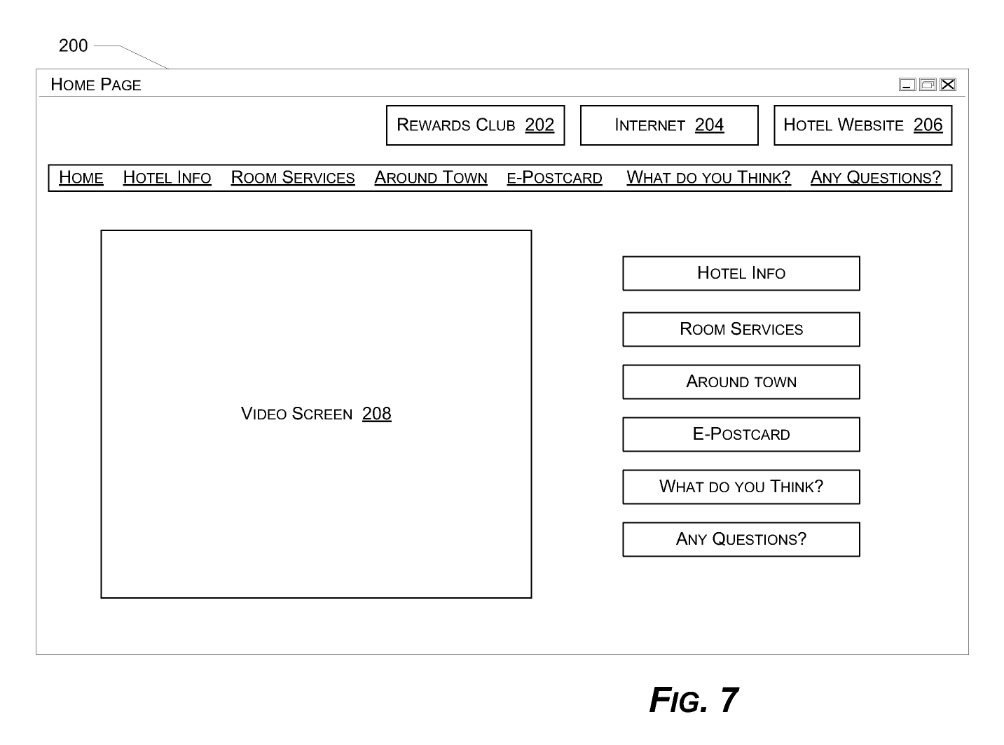

FIG. 8 illustrates an example menu system revealing nested menu options for the graphical user interface 200 of FIG. 7. The menu choices illustrated in FIG. 8 are merely examples of various services that can be implemented through the centralized electronic menu and concierge service 100 of the present invention. Other services can be added dependent upon the service environment in which the service agent is deployed. For example, in a cruise ship context, a user may be able to reserve a shuffle board court, view a sailing schedule, or make reservations to a dance.

The menu options in the menu system of FIG. 8 may be provided in a number of different ways, included, but not limited to, drop down menus, buttons, pop-up windows, expansion menus, or other graphical user interface tools. In addition, the items may be presented in any desirable order, grouping, or location.

The user graphical interface 200 shown in FIG. 7 shows a general representation of a home page for the system 100. In accordance with an embodiment, the home page includes buttons 202, 204, 206 for access to a rewards club for the hotel chain, the Internet, and the hotel's website, respectively. These buttons may persist through all pages of the system 100, a subset of all pages, or may be available only on the home page. The buttons may alternatively be presented as a drop down menu or in another format. In addition, the selection of buttons shown is but one grouping of buttons or features that may be provided, and more or different features may be available.

The buttons 202, 204, 206 (or a different set of buttons or features) may be deployed as a limited system toolbar (such as, by way of nonlimiting example, a top or bottom border of the Internet browser) such that, upon exiting the system 100 and browsing the Internet, the limited system toolbar may still be present to allow the user easy access to return to the system. In accordance with an embodiment, such a toolbar may also provide global functionality, such as hyperlinks to the hotel's reservations website or other system-defined websites. In accordance with another embodiment, a local administrator may select a particular set of features to be provided on the system toolbar. However, constraints may be placed on individual hotels to maintain branding of the system 100 throughout the hotels.

If desired, selection of each button may launch into a new window so that the user may easily navigate back to the graphical user interface 200. Also, if desired, guests may have the ability to change language and/or currency from the home page to one of other available language and/or currency options. The language and/or currency options may be provided via the localized information in the database 148, or the general information in the database 146. As an example, information about the particular language and/or currency options that are desirable for a particular hotel 106 may be stored as part of the localized information, and language and/or currency variations for the graphical user interface 200 may be stored in the general information database 146.

In the embodiment shown in FIG. 7, a welcome video is displayed in a video screen 208. This video may, for example, welcome the guest to the hotel and may be played automatically or may require a user to make a selection (e.g., click on a button) in order to play the video. The home page also includes links to the top nested menu options of the expanded menu shown in FIG. 8.

Some implementations of navigation through the menu of FIG. 8 are provided below. As described earlier, other options may be provided, and/or the features described herein may be provided in different ways.

Clicking on a “Hotel Info” button on the home page navigates the user to the hotel information page. Information about, or links to, Hotel Events, Directions, Hotel History, and Games are provided on this page, as can be seen by the nested menu options in FIG. 8.

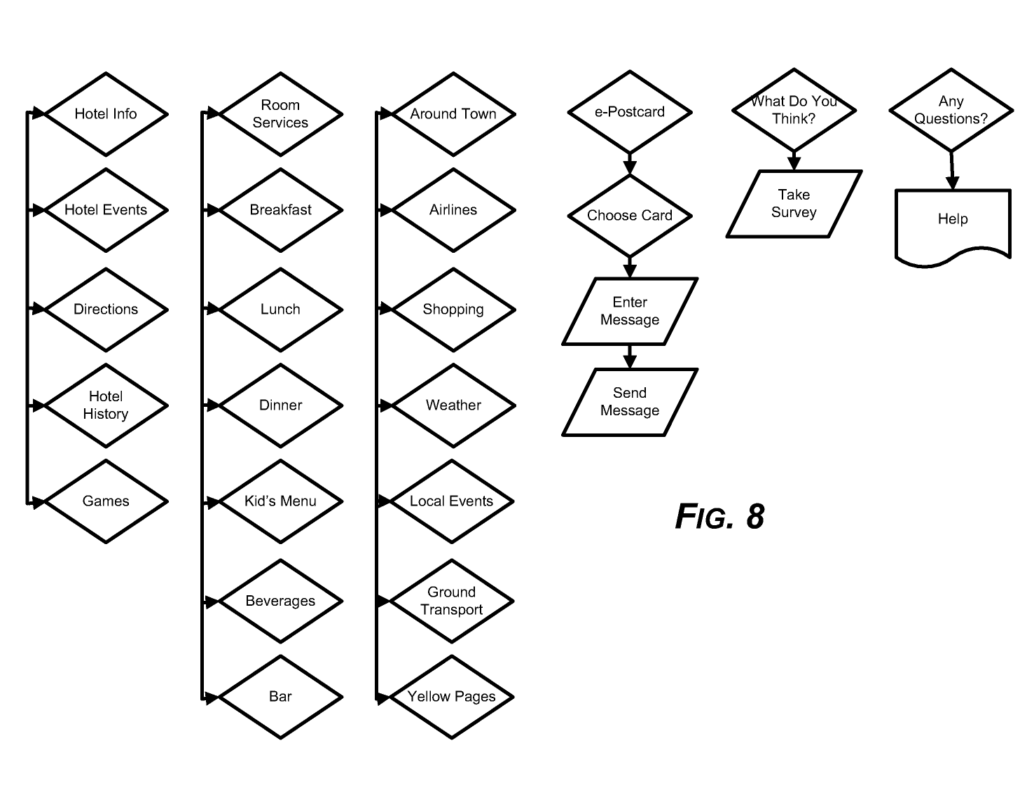

Further nested options that may be provided under “Hotel Events” are shown in FIG. 9. These further nested options may be provided, for example, on a “Hotel Events” page or pages, access to which may be provided by clicking on a “Hotel Events” button on the Hotel Information page.

The first of the “Hotel Event” options is “View Events.” This button allows a user to view a list of current events at the hotel, for example by navigating to a page or pages displaying the events. This feature permits a guest accessing the system 100 to see all events that are scheduled for the hotel 106. Each hotel provides hotel events that are fed into the system 100, for example via the localized information file 160 (FIG. 6). In response to a user selecting the “View Events” selection, the events are retrieved by the service agent 142 and are provided to the authorized user. Events provided for the list may each include a date stamp that permits an event to be automatically removed from the list once the event's date has passed.

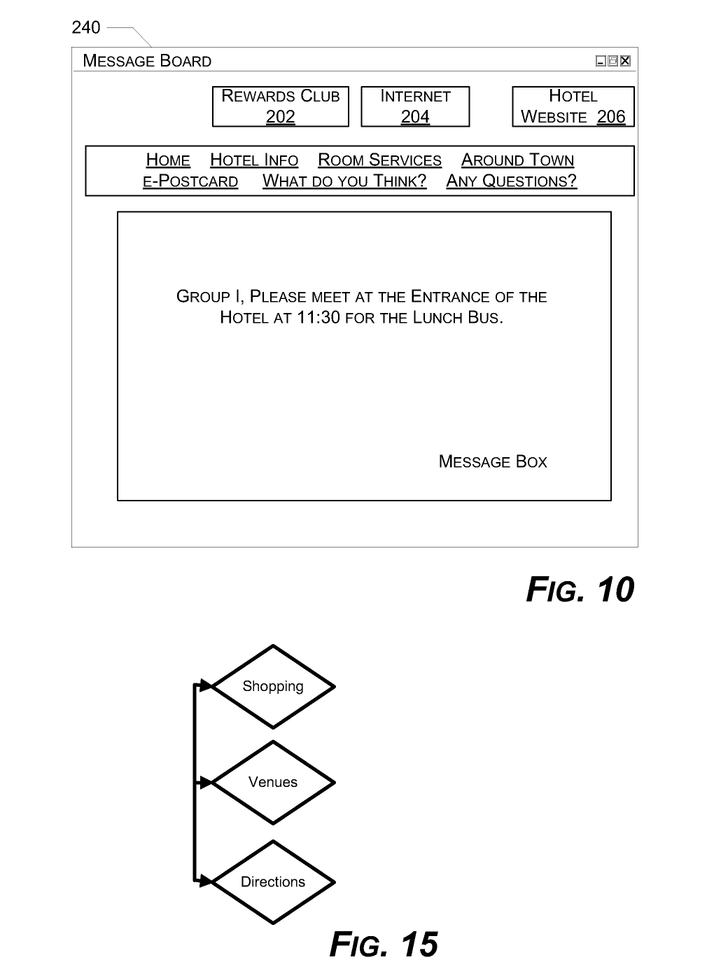

The “Hotel Events” page may also include a “Message Board.” This message board may provide hotel-wide messages, and/or may provide the ability for large or small groups to post and view private messages via the message board. A special password may be provided for access to a private message board. Alternatively, a user's user name and password may be associated with a particular message board so that automatic entry may be provided. An example is shown in FIG. 10, where a message board 240 is provided having a single message for group I. In the example shown, if the message board 240 is private, the user viewing the message board 240 is already authorized to access the message board. As stated above, a password or other credentials may have been previously required to access this information.

The user may select to display a map of the hotel by selecting a “View Hotel Map” button. A virtual tour of the hotel may also or alternatively be provided. In addition, the user may elect to print the hotel map, for example by selecting a “Print Hotel Map” button. In an embodiment, this function is provided only through the lobby terminal 130 via a printer 220 (FIG. 4). However, if desired, the printer 220 may be positioned in a localized area, such as at a concierge desk, a registration desk, or business center, and may be configured such that a command from the GUI permits a user to print to the printer 220 from anywhere within the hotel. For such commands, a user may be required to download a printer driver to a guest computer 132 before this function is enabled. Alternatively, the entire document may be sent to a specialized printer server which processes the document for printing. In another embodiment, a user may connect a computer directly to the printer 220 and may print, for example through a generic printer driver or through download or other installation of a printer driver.

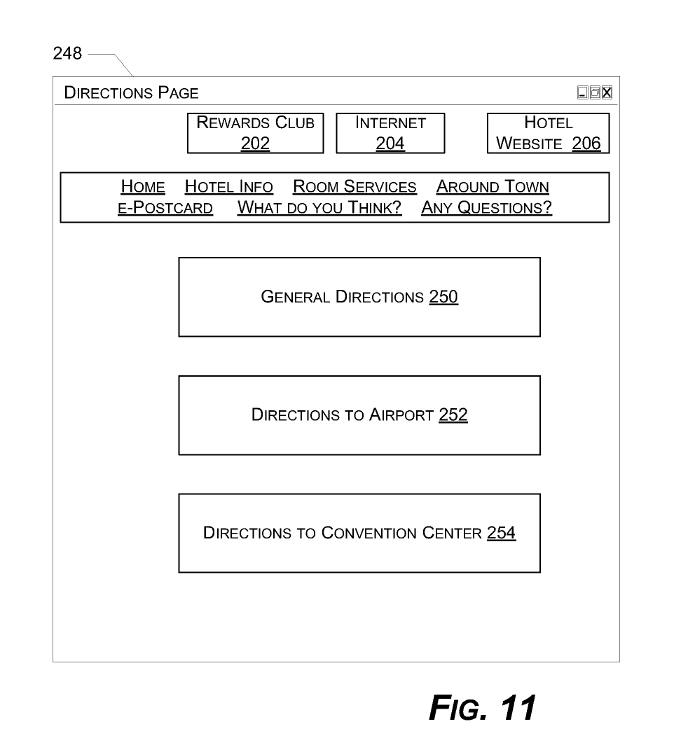

Another option under the hotel information menu is “Directions,” which allows a guest to get directions to or from the hotel. These directions may be provided via a known mapping website, such as www.maps.yahoo.com. If desired, common directions may be provided on a website to which the user navigates, such as directions to an airport or local attractions. An example “Directions” page 248 is show in FIG. 11, where a “General Directions” button 250 is provided, which may for example link a user to a mapping website with the starting address of the hotel already in place. In the example shown, a “Directions to Airport” button 252 and a “Directions to Convention Center” button 254 are also provided. Upon selecting either of these buttons, the service agent 142 provides the appropriate directions, for example, by providing the link to appropriate directions via the website www.maps.yahoo.com.

In an embodiment, the directions may utilize smart logic to provide most recently requested directions and/or most frequently requested directions. The directions may be displayed in chronological order, or in order of most frequent use, as examples. The directions may incorporate logic that, for each hotel, provides a standard set of directions (e.g., closest airport, closest rental car agency, closest shopping, etc.).

Also provided on the hotel information page is “Hotel History,” which may provide a history of the hotel chain, such as via static pages of information or a link to a history portion of the chain's Internet website. A “Games” link is also provided in which games may be selected by a user. These games may be, for example, Macromedia Flash games or other suitable games.

The “Room Service” features provided through the graphical user interface 200 may, in an embodiment, be available not only to a guest in the guest's room, but also to guests or other visitors who may be in the lobby or in other locations throughout the hotel, for example in a conference center at a meeting. As part of the room service function, a user may select delivery to the lobby, a meeting room, the restaurant, or the guest's room.

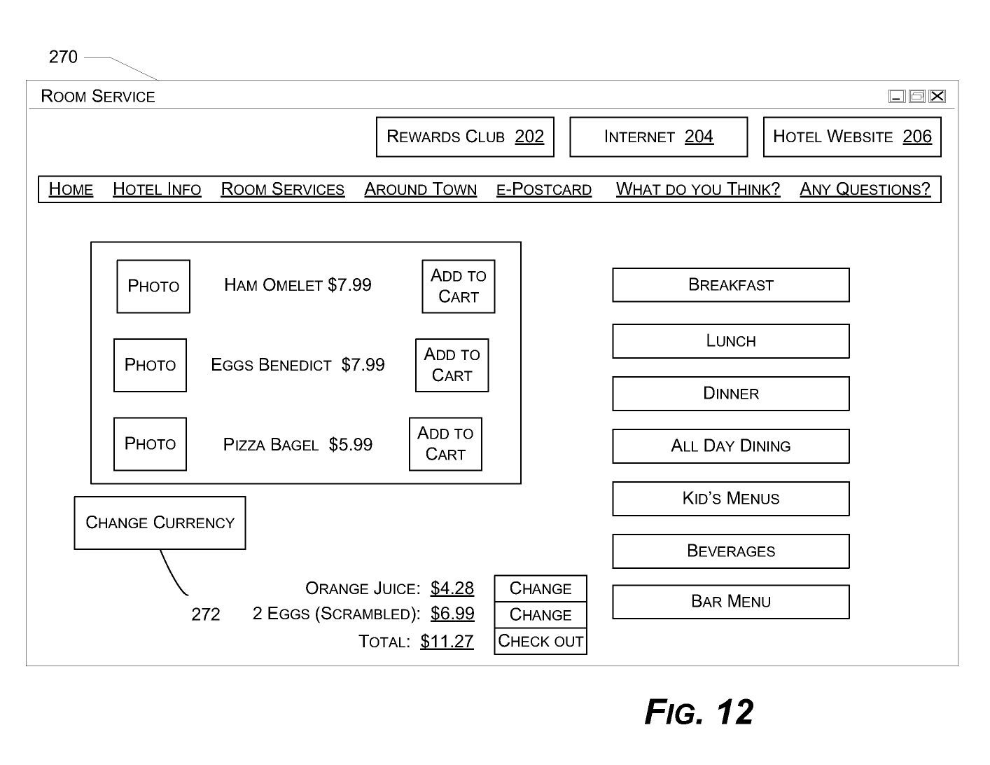

FIG. 12 shows a room service user interface 270 in accordance with an embodiment of the invention. The room service user interface 270 includes a view/create order screen that allows a guest to choose breakfast, lunch, dinner, all day dining, kids' menus, beverages and/or bar menus. Selecting one of these options results in display of menu items for the selection. Each of the menu items may include a photo, a price, and additional information. In accordance with an embodiment, a user may click on a menu selection and view more details about the selection, such as nutritional information, ingredients, recipes, and/or larger or additional photos. The items that are displayed for purchase and the prices of those items may be provided by either the localized information database 148, or the general information database 146. Use of the localized file 160 provides an easy way for the menu to be customized for a particular hotel 106, without each hotel having to create and maintain its own menu. Moreover, the additional data (such as, by way of nonlimiting example, the pictures, nutritional information, recipes and ingredients described above) may be maintained at one location, permitting efficiency in management of the menu system.

In accordance with an embodiment, the inventory control 150 maintains information about items that are no longer available for each of the hotels 106. The information for each hotel 106 may be provided to the specific hotel. The hotel 106 may use this information to aid in supply chain management.

The room service user interface 270 permits a user to add items to an order with shopping cart functionality. The order may display items in a running total and allow the guest to easily change quantities or remove items from the order. The guest may specify cash, credit card, or room charge for payment. In an embodiment, a currency button 272 is provided that permits a user to see the price of items on the screen and in the running total in a different currency. This feature may be provided, for example, by performing a calculation based upon conversion rates supplied by a currency website. If desired, an appropriate disclaimer may be provided indicating that the rates are approximate.

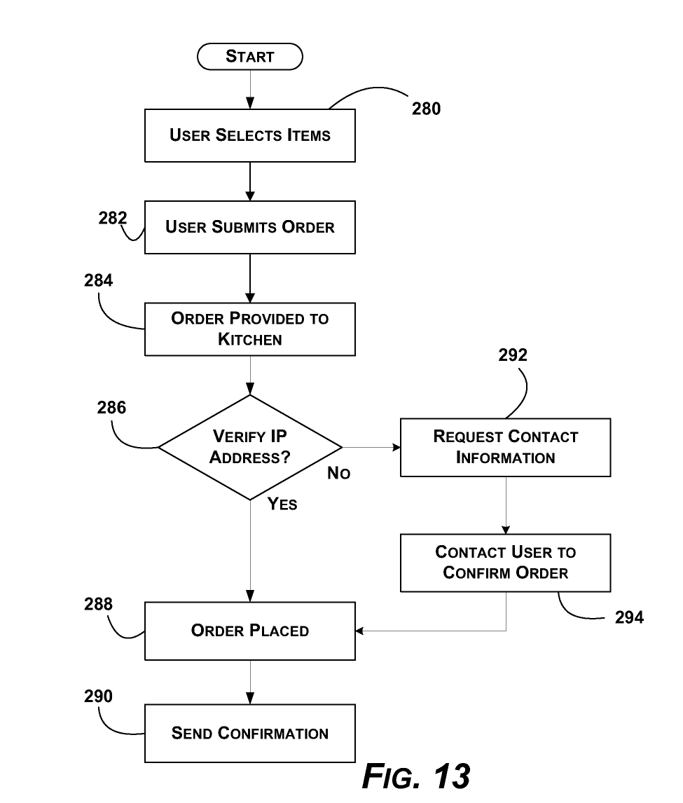

FIG. 13 shows a flow chart with steps for processing a room service order in accordance with an embodiment of the invention. Beginning at step 280, a user selects items such as is described above. At step 282, the user submits the order.

At step 284, the order is provided to the kitchen terminal 112 by the service agent 142. At step 286, a determination is made if the order was placed from a verifiable IP address. In accordance with an embodiment, as described above, IP addresses may be associated with particular rooms in the hotel. Thus, if it is known that the order is placed from a particular room (for example, because the order is placed via a verifiable IP address), and the order is requested to be sent to that room, then the order is most likely not a prank order. Accordingly, in accordance with an embodiment, if there is a verifiable IP address, then step 286 branches to step 288, where the order is placed. This may be done, for example, by e-mailing the order to the kitchen 112, or by printing the order at the kitchen, where the order is entered by kitchen staff into a point of sale system. Alternatively, the order may automatically populate a point of sale terminal at the kitchen, which may be confirmed by kitchen staff or may automatically posted for the kitchen.

At step 290, the user is sent a confirmation message, for example by the service agent 142. This may be an email, a message sent through the graphical user interface 200, or another appropriate message.

If the order is not placed from a verifiable IP address, then step 288 branches to step 292, where the system requests contact information from the user. This request may occur earlier in the process, such as before the order is submitted. At step 294, the user is contacted to confirm the order, for example via a cell phone number that was given at the time the order was placed. Step 294 then branches to step 290, where the order is placed. As an alternative, confirmation may be made automatically. For example, if the phone system 122 is an automated system, such as a voice over IP system, then providing a confirmation phone number may result in the user being automatically called at the number. A request may be made (via the automated phone system 122) to enter a code or other information to confirm the order. The code may have been previously provided to the user, may be a rewards number for the user, or may be some other information that is private to the user.

As part of the electronic menu and concierge system 100 an electronic menu may be provided through which users may order restaurant service, including a request for food and/or beverages. This system may be similar to the room service features above, but directed to the actual menu items available in a restaurant for the hotel 106 or in an offsite restaurant with which the hotel has an agreement for service or is otherwise affiliated with the hotel. This electronic menu service may be accessed, for example, via one of the guest computers 132 or via the restaurant terminals 134. If placed by one of the guest computers, an order may be for pick-up, dining in the restaurant, or delivery.

A similar electronic menu service, called the EMENU service, is currently provided by the assignee of the present invention. The EMENU service is implemented by a server computer at the hotel at which it is provided, and is separately implemented and managed for each hotel. In contrast, the electronic menu functions of the system 100 are centralized through the data center 102. For the electronic menu portion of the electronic menu and concierge system 100, there may be a number of items that are standard to an entire chain of hotels, and which are provided via the data center 102 through the general information database 146. As an example, information about specific menu items may be maintained at the centralized data center 102, and that information does not have to be replicated and maintained at a large number of hotels. If desired, a particular hotel 106 may change prices, specials, or delete items for its personalized menu by providing localized information to the data center 102 via the localized interface 170. This information may be stored in the localized file database 148. In addition, an administrator may add menu items that are unique to the hotel, including adding pictures and description of these unique items, and nutritional information, modifiers, and daily specials. However, the centralized nature of the data center 102 provides a number of efficiencies because of the lack of the need for duplication of data and management.

Information for food and beverage services for a particular hotel 106 may be maintained in a number of different ways by the data center 102. As an example, for each hotel 106, the localized information file 160 may include a list of items that are to be served by the hotel, and prices to be charged for those items. The nutritional information, photos, and other information about the items may be maintained in the general information database 146. When a user requests a food menu, the service agent 142 accesses the localized information file 160 to get the appropriate items and prices, and accesses the general information database 146 for other items to be displayed with the items. The combined information is then provided to the user.

As an alternative, a default menu may be provided by the data center 102, and the localized information file 160 may provide differences between that default menu and a desired menu for the particular hotel 106. When a user requests a food menu, the service agent 142 accesses the default menu and the localized information file 160, makes any changes needed to the default menu, and provides the information to the user. Other variations may be used.

The “Around Town” menu items shown in FIG. 8 include a selection of “Airlines.” FIG. 14 shows menu items that may be available at an “Airlines” menu (for example, on an “airlines” page of the GUI 200) in accordance with an embodiment of the invention. One of the selection items includes “View Schedules.” Selecting this link allows a guest to select an airline from the drop down list and redirects the guest to the airline's homepage. Another option would direct a guest to an airline arrival reporting website, such as www.flightarrivals.com.

A second link, “Print Ticket,” provides the opportunity to print an airline ticket. The guest may select the airline and is redirected to the airline's homepage where the user may print airline tickets, receipts, or boarding passes. This printing option may be available only from a particular terminal, such as the lobby terminal 130, or may be available from other places in the hotel 106, such as the guest's room, if appropriate software and/or hardware are available as described above.

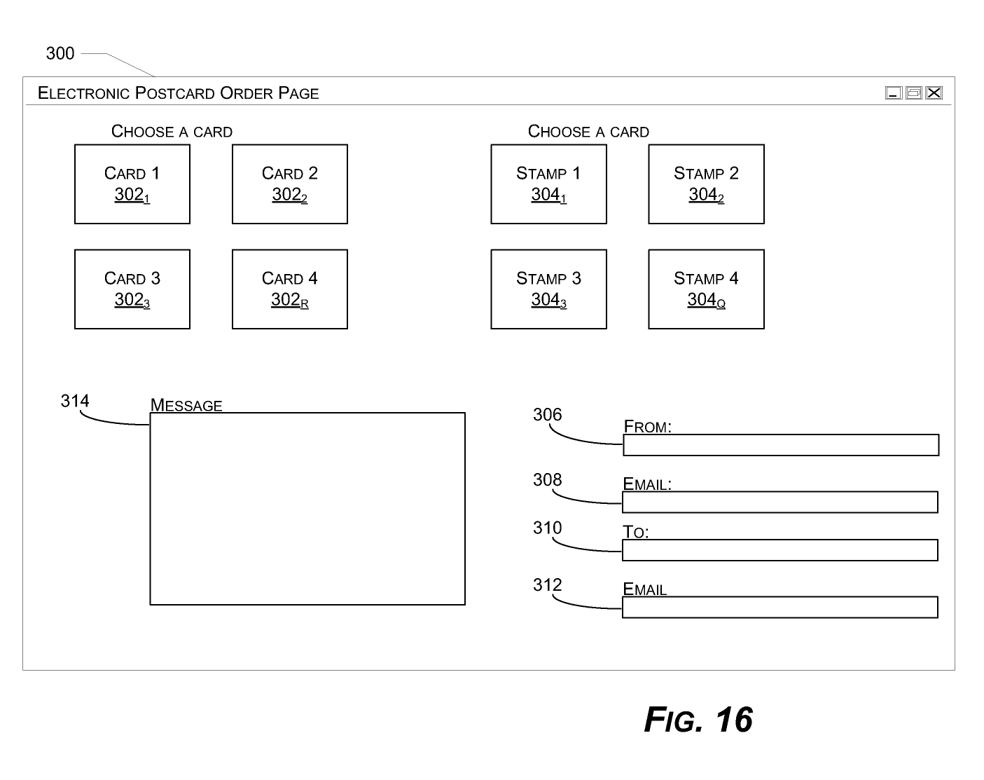

FIG. 15 shows menu items under the “Shopping” link in accordance with an embodiment of the invention. Included among these is “Venues” in which a guest may view a list of categorized shopping venues, such as: books and magazines; clothing and accessories; computer software; electronics; general merchandise; gifts, flowers and food; health and beauty; office supplies; and sports and outdoor equipment. Information for each of these venues may provide one or more links, phone numbers, or other information about local merchants that provide services or goods in the category. Other venues may be provided. The “Venues” information is provided, for example, via population from a third party provider. Alternatively, this information may be provided by each hotel 106, for example via the localized information file 160. When a user requests the information, the service agent 142 retrieves the information and provides it to the user, for example on a web page. Directions to particular shopping selections may be requested using a “Directions” link under the “Shopping” menu.

A “Weather” link under the “Around Town” menu provides weather information, such as local weather, and may provide a link to access a forecast for other cities. This information may also be stored in the localized information database 148. However, instead of being populated by the localized information file 160, this information may instead be supplied by an administrator of the data center 102. The information may be provided, for example, by a link to a local forecast provided via a weather information website.

Also included in the “Around Town” menu is “Local Events.” Selecting this feature allows a user to view a list of current local events. These may be, for example, provided by a third party supplier, or may be populated by each hotel 106, for example via the localized information file 160. In an embodiment, the events are dated so that they are automatically removed from the list after they have expired.

The “Ground Transport” link under the “Around Town” menu includes localized information for ground transportation, such as bus schedules, telephone numbers for taxi cabs, links to arrange taxi services, if available, opportunities to rent vehicles via linking the user to national or local rental companies' website(s), and directions to subway systems, if relevant. This information may also be populated via the localized information file 160, or may be populated by a third party provider. A “Yellow Pages” link may direct a user to a Yellow Pages information service on the Internet, such as www.yellowpages.com.

Pages of the “Around Town” menu, or other sections of the system, may provide advertising opportunities. For example, a page or pages related to “Ground Transport” may include advertising for local taxi cab services or car rental companies, and so forth.

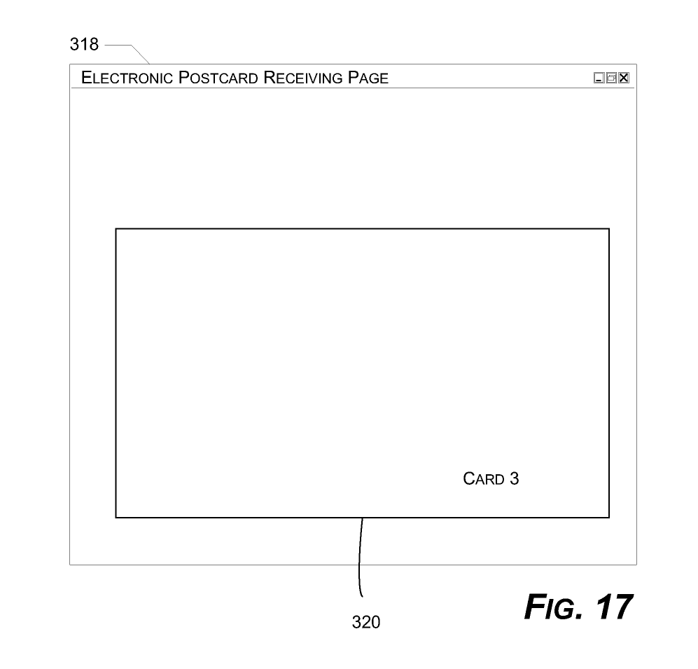

FIGS. 16-18 show graphical user interfaces for sending and receiving an electronic postcard in accordance with an embodiment of the invention. Upon selecting the “epostcard” menu item in the graphical user interface, a user is directed to the “Choose Card” screen 300 shown in FIG. 16. The user interface 300 allows a user to select from among several cards 302₁, 302₂ . . . 302R. In addition, the user is prompted to select from among different stamps 304₁, 304₂ . . . 304Q. Data entry fields 306, 308, 310, 312 are provided for entering the name and e-mail address of the sender and recipient(s), and a message box 314 is provided. After the user has selected a card 302 and stamp 304 and entered the appropriate information, the system is prepared to send a card. The user may be provided a screen in which to view and approve the postcard before sending.

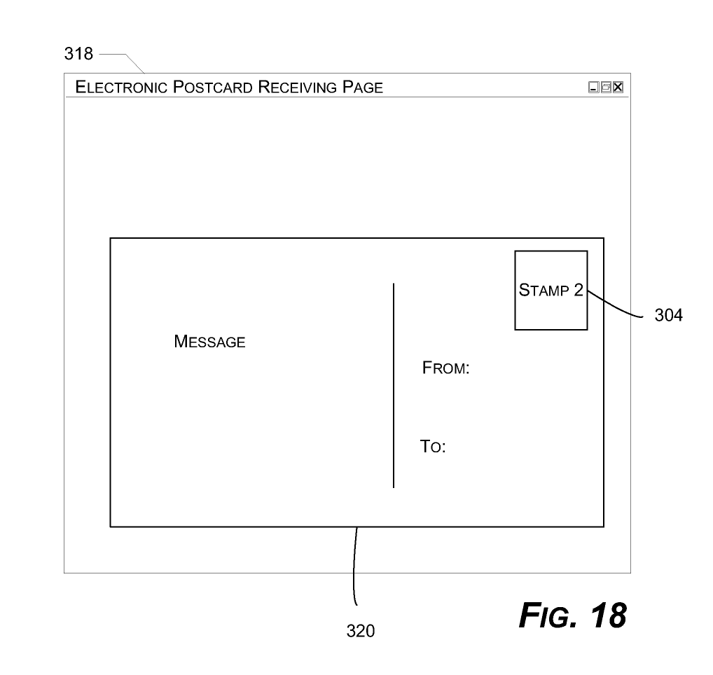

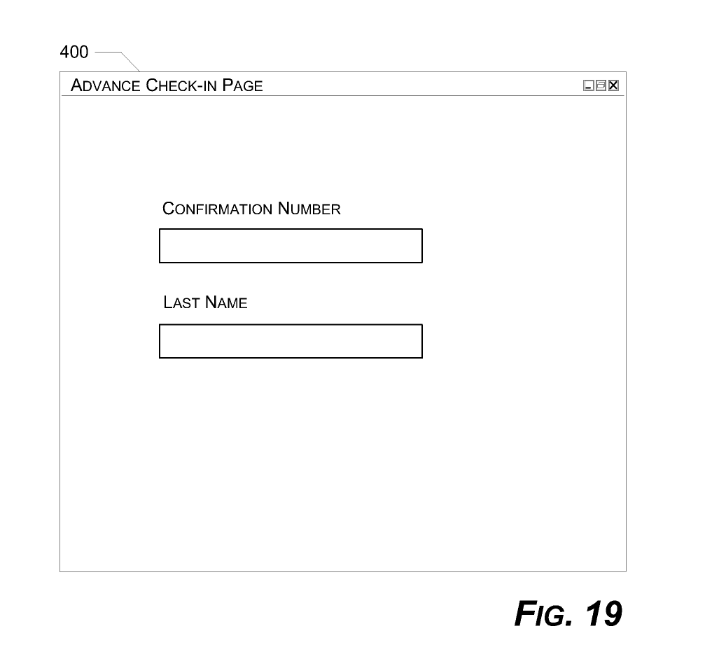

In accordance with an embodiment, the electronic postcard is shaped and proportioned like a conventional mail postcard; that is, the electronic postcard has an aspect ratio of a width of 5.5 inches to a height of 3.5 inches. Thus, a user sending or receiving a card is provided a visual impression of an image that simulates an actual postcard. When viewing the card, a sender or recipient may view either the front or back of the card. The front (FIG. 17) includes the chosen design (e.g., the card design 302₁, 302₂ . . . 302R), and the back (FIG. 18) includes the message, the sender and recipient information, and a mock postage stamp.

When the card is sent, a user receives a link to the electronic postcard via an email. Upon clicking on the link, the user is directed to a page 318 having a visual representation 320 of the electronic postcard, such as is shown in FIG. 17. When the user clicks on the postcard, the card rotates and turns over so that the user may see the back of the electronic postcard (FIG. 18). On the back, the message entered by the sender in the message box 314 is provided where messages are typically provided on conventional postcards (to the left and centered), the mock postage stamp 304 selected by the sender is positioned in the normal location of a conventional stamp (upper right corner), and the sender and recipient information are provided at the mailing address section where a typical postcard mailing section is located (i.e., the middle right of card).

In accordance with an embodiment, the view for the front of one or more of the electronic postcards 302 may include localized information, such as information about or a picture of an attraction near the hotel 106. The card may also include hotel-specific information, such as a sign on the outside of the hotel, or a picture of the hotel. Other postcard options may be provided that are not specific to the hotel or the location of the hotel.

A “Email the General Manager” menu item provides a survey to permit users to comment on the electronic menu and concierge system 100, and to contact the general manager of the hotel via email directly. An additional survey may be provided to collect comments regarding the hotel 106.

An “Any Questions” menu item provides online help for using the electronic menu and concierge system 100. In addition, an area for hotel inquiries may be provided, such as permitting a user to send a request to the housekeeping computer 116 to request personal items that had been forgotten, to send a request to the management computer 114, and so forth. These messages may be sent directly to the housekeeping computer 116 or the management computer 114, permitting a response or appropriate reaction. For example, a user may send a request for additional towels. The request may be routed to the housekeeping computer 116, and may be printed or otherwise handled by a recipient in housecleaning.

In accordance with an embodiment, a paging system 350 (FIG. 4) is provided that permits a user to send a request through the electronic menu and concierge system 100 which in turn generates a page to one of many pagers 352₁, 352₂ . . . 352_{S}. These pagers may be carried, for example, by housekeeping staff, management, room service staff, or other hotel employees. For example, a request for bellhop service through the system 100 may result in a page being sent to a front desk pager 352.

In accordance with another embodiment, the electronic menu and concierge system 100 may offer a merchandise or shopping page, where a user may order goods from a gift shop in the hotel 106, and have the goods placed on the user's bill. Alternatively, a function may be provided for paying by credit card or in another way. The order may be sent to the gift shop computer 118, and the order may then be handled by the gift shop, for example by confirming an order that is automatically placed in a point of sale computer, or by manually entering the order in a point of sale system.

In accordance with an embodiment, security measures for billing goods and services, including food, to a guest room may be imposed, such as, by way of nonlimiting examples, the authentication methods described above for room service verification (e.g., via IP address verification), by means of the hotel staff confirming an order by placing a telephone call to the room, by means of an automated message delivered via the telephone to confirm the guest's order, or other methods.

The goods may then be delivered to the user's room or made available for pick up. In addition, if desired, the merchandise or shopping area may provide items for sale from local stores. These items may be paid by giving a credit card number that is in turn given directly to the store, may be put on the room bill, or may be paid to the hotel 106 for later credit to the local merchant. The items may be delivered to the hotel 106 for routing to a guest, or may be marked for pickup by the guest.

In accordance with another embodiment, the electronic menu and concierge system 100 may maintain customer information, for example stored in a customer database 360 (FIG. 5). This customer information may include preferences of a customer, so that when a customer returns to a hotel in the hotel chain, the customer may be provided individualized service based upon prior requests by the customer. As examples, the customer information database may maintain information about a particular customer that prefers a feather pillow and decaffeinated coffee, and may automatically have these items delivered to the customer's guest room upon arrival. Alternatively, an inquiry may be generated within the system to determine whether the customer would like the service or amenity again.

In an embodiment, the customer database 360 may maintain previous food orders by a customer, at a restaurant and/or via room service. The system 100 may use this information to request whether the user would like the same menu item again, or may use previous ordering experience to otherwise such a menu item. As part of the suggestion process, a shopping cart may be pre-populated with menu items when a user registers with the system and enters the menu service or room service.

In accordance with another embodiment, the web server 110 and/or the data center 102 may be configured to allow remote users 370₁, 370₂, . . . 370_{T} (FIG. 4) to access the system so that a user may become familiar with the hotel 106 or the system 100 prior to arrival, or may take advantage of other services provided by the system 100. As an example, a remote user 370 may want to view hotel events, or get directions to the hotel. The system 100 may be configured so that remote users 370 may also access a number of other features of the electronic menu and concierge system 100. As examples, the hotel information may be accessed, and the “Around Town” menu may be provided. This feature offers an authorized user to plan portions of a trip through the hotel's website in advance of arriving at the hotel 106. A user may determine a restaurant for visiting upon arrival, or may find an office supply store near the hotel 106 that may alleviate the need for an extra trip. An authorized remote user may also pre-order room service for the user's room, or a meal from the restaurant for pick-up or dining in the restaurant.

The remote users 370 may be authorized users accessing the system via a computer such as the computer 10. In addition, a terminal or terminals may be provided at an airport for accessing the system, or a terminal may be provided on a shuttle bus offered by the hotel 106.

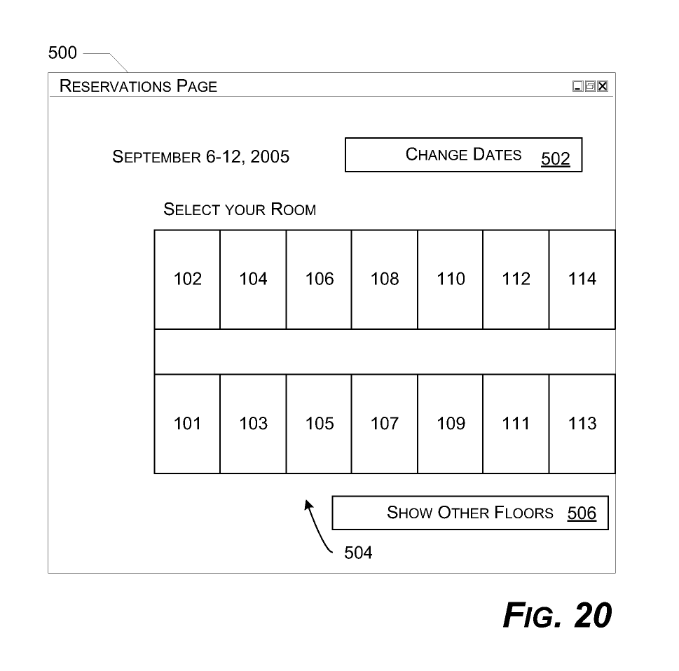

In addition, in accordance with an embodiment, a user may be permitted to view an advance check-in page 400 (FIG. 19) so that the remote user may check in via the Internet. The check-in page 400 may require appropriate credentials, such as a reservation confirmation number and last name, a rewards program number, or a previously-provided username and password. A user may provide appropriate credentials and may then be checked into the hotel 106 prior to arrival. Then, upon arriving at the hotel, the user simply picks up his or her key or goes directly to the room if a key is not needed. A check out page may similarly be provided that shows a user his or her bill and permits the user to confirm and check out of the hotel 106. Printing functions may be provided if desired.

In accordance with an embodiment, the service agent 142 may be connected to a reservation system 498 (FIG. 5). This reservation system 498 may be maintained at the data center 102, or may be maintained separately from the data center. The reservation system 498 permits a user to make reservations with one of the hotels 106, or to edit or otherwise change an existing reservation.

An example of a reservations page 500 that may be presented to an authorized user is shown in FIG. 20. In the example shown in FIG. 20, a reservation already exists, but the guest has not yet checked into the hotel.

In the example shown in FIG. 20, the guest is provided an opportunity to change the dates of the reservation via a “Change Dates” button 502 and may be permitted to select a room in advance via a map 504 (only a portion of the map of the hotel is provided). If needed, a button 506 may be provided for allowing the user to view rooms on other floors.

In accordance with an embodiment, different pages may be provided for making a reservation or after a guest has checked into the hotel. For example, if a user wishes to make reservations, a page may be provided for selecting a time and place. After selecting the time and place, the user may be provided an opportunity to select a room (e.g., via a hotel map such as the hotel map 504), provide a credit card number, and so forth. For an existing reservation, a user may be provided an opportunity to change a check out date or other functions.

A number of other features may be added to the graphical user interface. For example, “Current Events” links could be provided for ordering tickets to events. Golf tee times or other reservations may be made. Restaurant reservations may also be made. This information may be populated into or linked to the data center 102 via a third party provider, for example.

In accordance with an embodiment, video conferencing features may be provided in the electronic menu and concierge system 100. These video conferencing features may be accessed using the graphical user interface 200.

In another embodiment, entertainment may be provided through the electronic menu and concierge system 100, for example via an entertainment component 400 (FIG. 5), or a localized equivalent. As an example, a user may select a pay-per-view or free movie, music, map information, satellite radio, or other digital entertainment or content, which may be provided via the centralized data system 102, or may be authorized via the electronic menu and concierge system 100 for local viewing or enjoyment. This digital content may be made available to devices, such as radios, stereos, or televisions, provided by the hotels 106, or may be made available for download for use by personal computing devices, such as MP3 players, media players, and so forth. As a download example, the electronic menu and concierge system 100 may provide Podcasts of music or audio-book format downloads of regional/local history or points of interest for guest to download and enjoy while visiting a particular region. Guests may also submit stories to be programmed onto Podcasts.

The electronic menu and concierge system 100 of the present invention provides a number of benefits. The centralized data center 102 provides a single location where the administration of electronic menus and a number of concierge services may be provided for a large number of hotels 106. For general information used by more than one of the hotels 106, a single update at the data center 102 ensures that data available for all the hotels is current. The centralized data center 102 also offers an opportunity for consistent branding of web services and enhanced customer service initiatives throughout a chain of hotels.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer system, comprising:
a centralized, Internet-hosted service that is accessible by users of a plurality of travel and hospitality locations, the service including, for each location, providing to the location (1) information specific to the location and (2) information applicable to more than one of the locations.

2. The computer system of claim 1, wherein, for each location, the service is accessible by a user at the location via the individual's portable computer.

3. The computer system of claim 1, wherein, for each location, the service is accessible via a wireless network.

4. The computer system of claim 1, wherein, for each location, the service is accessible through a terminal provided by the location.

5. The computer system of claim 1, wherein, for each location, the service is accessible by authorized users while not on the premises of the location.

6. The computer system of claim 1, wherein, for each location, the service is accessible by authorized users while not on the premises of the location via a website through the Internet.

7. The computer system of claim 1, wherein, for each location, the service provides information about the location.

8. The computer system of claim 1, wherein, for each location, the service provides directions from and to the location.

9. The computer system of claim 1, wherein, for each location, the service provides information about events at the location.

10. The computer system of claim 1, wherein, for each location, the service provides games.

11. The computer system of claim 1, wherein, for each location, the service provides food and beverages services.

12. The computer system of claim 11, wherein, for each location, food and beverages services may be ordered as a room service request.

13. The computer system of claim 12, wherein, for each location, further comprising a component for confirming authorization of a room service request.

14. The computer system of claim 13, wherein the component is configured to evaluate an Internet Protocol address to determine a room from which the room service request was issued.

15. The computer system of claim 13, wherein the component is configured to issue a request for a phone call to confirm the room service request.

16. The computer system of claim 13, wherein the component is configured to generate an automated message delivered via telephone to confirm the room service request.

17. The computer system of claim 11, wherein the food and beverages services comprise nutritional information about food available as part of the services.

18. The computer system of claim 1, wherein, for each location, food and beverages services may be ordered for a restaurant at or affiliated with the location.

19. The computer system of claim 18, wherein the food and beverages services may be ordered at a computer within the restaurant.

20. The computer system of claim 18, wherein the food and beverages services may be ordered at a computer outside the restaurant.

21. The computer system of claim 1, wherein, for each location, the information specific to each location includes a subset of information about local shopping venues, information about local weather, taxis and other ground transportation services, and local telephone numbers.

22. The computer system of claim 21, wherein the subset of information comprises information provided by a third party provider.

23. The computer system of claim 1, wherein, for each location, the service comprises an electronic postcard subsystem configured to permit a user to send an electronic postcard to a recipient.

24. The computer system of claim 1, wherein, for each location, the service comprises a feedback mechanism to communicate directly with the hotel management.

25. The computer system of claim 1, further comprising, for each location, an administrative terminal configured to access and edit the information specific to the location.

26. The computer system of claim 1, further comprising, for the service, an interface permitting, for each location, access and editing of the information specific to the location.

27. A computer system, comprising:
a centralized, Internet-hosted service that is accessible by users of a plurality of hotels, the service including a reservations component that is configured to provide computerized check-in to a hotel.

28. A computerized method of providing service to a travel and hospitality guest, comprising:
maintaining information about requests made by a user; and
providing suggested services to the user based upon the information.

29. A computer system, comprising:
a centralized, Internet-hosted service that is accessible by users of a plurality of hotels, the service including an electronic postcard subsystem configured to permit a user to send an electronic postcard to a recipient.

30. A computer system, comprising:
a centralized, Internet-hosted service that is accessible by users of a plurality of hotels, the service including a reservations component that permits a user to access a reservation for viewing or editing of the reservation.

31. A computer system, comprising:
a centralized, Internet-hosted service that is accessible by users of a plurality of hotels, the service including an entertainment module that permits a user to access and download digital content.

32. The computer system of claim 31, wherein the digital content comprises a Podcast.

33. The computer system of claim 31, wherein the digital content comprises an audio book describing regional features of interest.

34. The computer system of claim 31, wherein the digital content comprises map information.

35. The computer system of claim 31, wherein the digital content comprises a movie.

36. The computer system of claim 31, wherein the digital content comprises music.

37. The computer system of claim 31, wherein the digital content comprises satellite radio.

38. The computer system of claim 31, wherein the digital content is downloadable to a personal computing device.
